(19) United States
(12) Patent Application Publication
(10) Pub. No.: US 2014/0006207 A1
(43) Pub. Date: Jan. 2, 2014

(54) Two-Dimensional Code Reader with Location Identifier

(71) Applicants: Gary Koelling, St. Michael, MN (US); Bob Boerschel, Lakeville, MN (US)

(72) Inventors: Gary Koelling, St. Michael, MN (US); Bob Boerschel, Lakeville, MN (US)

(73) Assignee: BBY SOLUTIONS, INC., Richfield, MN (US)

(21) Appl. No.: 13/534,521

(22) Filed: Jun. 27, 2012

(51) Int. Cl. G06Q 30/00; G06F 15/16

(52) U.S. Cl. 705/26.61

(57) ABSTRACT

A device and method is presented that responds to a QR code associated with a product with information retrieved from a remote server about that product. A mobile device reads a QR code and then requests product information from the server. In addition, the mobile device also informs the server of its geographic location. The server then responds with product information that is customized according to the geographic location of the device. If the device is within a retail store, the server customizes the information for that retailer and does not include competitive pricing information. If the device is not within a known retail store, the product information may include competitive pricing information.

### FIELD OF THE INVENTION

The present invention relates to the field of two-dimensional codes such as QR codes. More particularly, the invention relates to a computer server that responds to a request from a mobile device for product data relating to a QR code, where that response is based on whether the mobile device is currently found in a physical retail store location.

### SUMMARY

The disclosed embodiment of the present invention includes a mobile device that includes a camera that is capable of reading a two-dimensional code off of a product, product packaging, or a sign relating to a product at a retail location. The mobile device contains programming that evaluates the QR code in order to identify a network location from which data relating to the product can be retrieved. The network location may be a World Wide Web URL. Utilizing that product identification or network location, additional programming on the mobile device requests product specific data from a remote server over the network.

The mobile device will also provide the current geographic location of the mobile device to the server. This information is provided either along with the original data request made to the server, or in response to a request for location information that is made from the server to the mobile device.

The server compares the location information provided by the mobile device against a database of known store locations. If the location information indicates that the mobile device is likely located within a physical store location, the server responds to the data request with customized product information relevant to a shopper within that store. For example, the product information returned to the mobile device may identify the store by including the store's logo or other trademark. The server can also access store or retailer specific data in order to include the retail store's current price for the product as well as any specific promotions occurring at the store related to that product. The store specific information may also allow the server to provide the mobile device with suggested accessories, warranty service pricing, and ratings for the product provided by other customers of that retailer.

If the location information provided by the mobile device indicates that the mobile device is likely within a residence, then the product information returned to the server will include information relevant to the owner of that product. For instance, the server can access manufacturer data to provide the customer with “getting started” information, instruction manuals, and offers for accessories and services provided by the manufacturer.

If the location information provided by the mobile device is not clearly within a known retail location, and yet does not appear to be a residence, then the product information returned by the server will include general product information, consumer reviews, and competitive shopping information such as the current selling price of the product at nearby retailers. This would be particularly useful to a user that spotted the two-dimensional code on an advertisement away from their home.

The mobile device can also provide user information to the server, allowing the server to tailor the product information to the particular user. The user information can take the form of a cookie that uniquely identifies the user. The server can then maintain a user information database to recall stored information about that user. In one embodiment, the server coordinates this user identification information with a retailer customer database in order to tailor the information according to past purchases of the user.

### BRIEF DESCRIPTION OF THE DRAWINGS

FIG. 1 is a schematic view of the primary components and elements used in a first embodiment of the present invention.

FIG. 2 is a flow chart showing the method of implementation of the embodiment shown in FIG. 1.

FIG. 3 is a schematic view of the primary components and elements used in a second embodiment of the present invention.

FIG. 4 is a flow chart showing the method of implementation of the embodiment shown in FIG. 3.

### DETAILED DESCRIPTION OF THE INVENTION

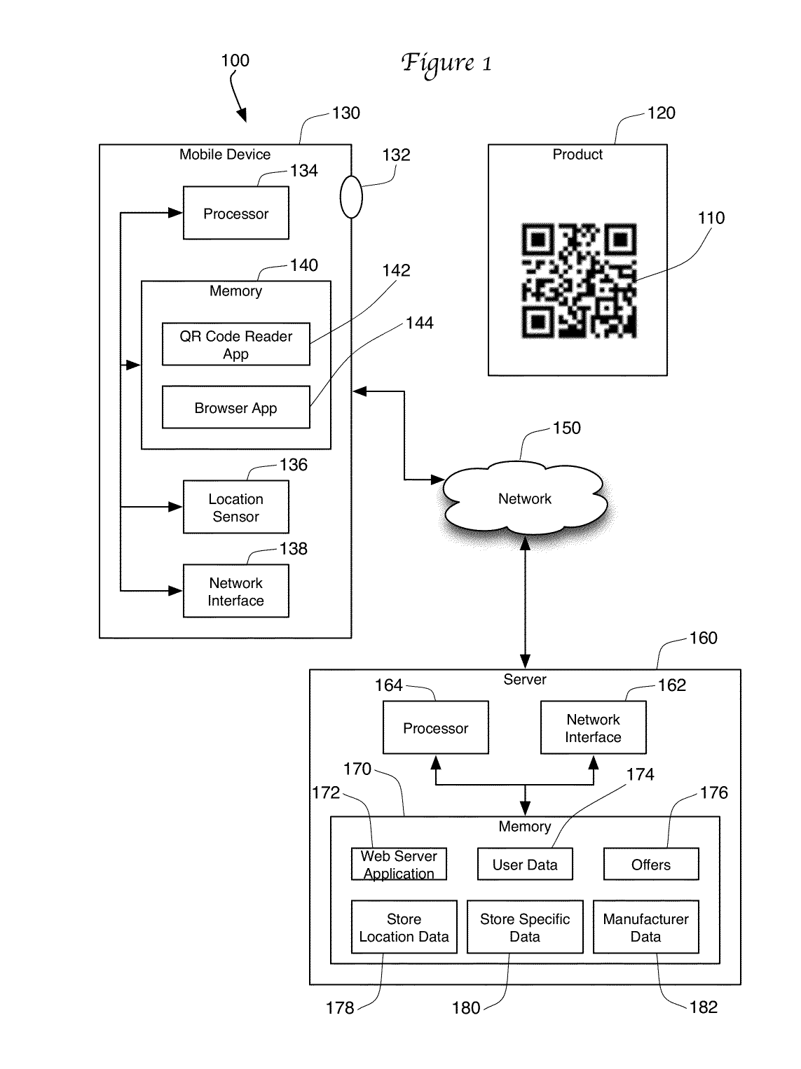

FIG. 1 shows a system 100 that is capable of reading a two-dimensional code such as the QR code 110 shown in FIG. 1. These types of two-dimensional codes (also known as matrix barcodes) hold more information than linear or one-dimensional barcodes. QR codes 110 are now frequently used in advertising and on products to direct users to locations (URLs) on the World Wide Web for more information about a particular product or service. In FIG. 1, QR code 110 is shown printed on the outside of a product 120. This location allows a user to obtain more information about the product by scanning the code 110 with a QR code reader. Information within the code 110 directs the users to a particular URL on the World Wide Web. It is not necessary that the code 110 appear on product 120 itself, as the invention is equally useful if the code 110 is printed on the product packaging, on signage located near the product 120 on a store shelf, on advertisements for the product 120, or in manuals or other materials that are provided along with the product 120 to the product purchaser. In each of these locations, a user will easily associate the code 110 with that product 120.

In the preferred embodiment, the URL found within the QR code 110 is associated uniquely with the product 120. For example, the URL may include some type of identifier for the product as a parameter within the URL string. In other embodiments, the QR code 110 contains a product identifier separate from the URL. In these embodiments, the QR code reader is responsible for proper handling and transmission of the product identifier to a remote server 160, as the identity of the product 120 could not be determined solely by the URL that is used to communicate with the server 160. In yet another embodiment, the QR code 110 contains only a product identifier and no URL. In these embodiments, the QR code reader must have knowledge about the network location of the server 160 that will provide information about the product 120.

In FIG. 1, a mobile device 130 reads the QR code 110 by taking an image of the code 110 using an imaging lens 132 integrated into the device 130. A processor 134 in the mobile device 130 interprets the image of the QR code using programming instructions 142 stored on a memory device 140. These programming instructions 142 may take the form of software, such as an application or “app” that can be implemented by the processor 110. For example, the mobile device might be an iPhone smart phone by Apple, Inc. (Cupertino, Calif.). In this case, the processor is an Apple A4 or A5 processor, also by Apple, Inc., which is based on the ARM processing architecture by ARM Holdings PLC (Cambridge, UK). The programming instructions that read the QR code could be implemented into the iOS operating system provided by Apple, Inc. on the iPhone, or could be implemented in an “app” downloadable at the Apple or iOS App Store. Alternatively, the mobile device might be a tablet computer such as those provided by Samsung Group (Seoul, KR) and sold under the Galaxy brand, which operate on the Android operating system created by Google Inc. (Menlo Park, Calif.). The memory 140 in either example would be solid state, non-volatile memory, typically Flash memory. The memory 140 of the mobile device 130 will likely also include volatile RAM memory, into which application software and data can be loaded for faster access by the processor 134.

The mobile device 130 also includes a geographic location sensor 136, which could take the form of a GPS chips such as those chips provided by Broadcom (Irvine, Calif.). These chips are able to identify the geographic location (i.e., longitude and latitude) of the mobile device 130 based on the receipt of GPS satellite signals. The location sensor 136 could also work by inferring a geographic location based upon received network signals, such as WiFi and Bluetooth MAC addresses, and GSM or CDMA cell tower IDs. In addition to the location sensor 136, the mobile device 130 also has a network interface 138 designed to allow the mobile device 130 to communicate with other devices over a wide area network 150. The network 150 may be the Internet, and the network interface 138 may comprise hardware and software components that allow WiFi or cellular data based connections to the Internet. The network interface may include the ability to handle network stacks for TCP/IP networks.

When the QR code 110 is read through the imaging lens 132, the QR Code reader app 142 running on the processor 134 will extract a network address or URL from the code 110. This network address can be used by a browser app 144, which is also stored in the memory 140 of the mobile device, to request data from a remote server 160 over the network 150 using the network interface 138.

The server 160 receives the request for information relating to the product 120 via its own connection to the network 150 through its network interface 162. Like the network interface 138 of the mobile device 130, the network interface 162 consists of hardware and software that allow communication between the rest of the server 160 and other devices over the network 150. The server 160 also has a processor 164, such as an i7 CPU provided by Intel Corporation (Santa Clara, Calif.) or a Phenom CPU provided by Advanced Micro Devices, Inc. (Sunnyvale, Calif.). Typically the Server 160 operates a general-purpose operating system, such as Windows from Microsoft Corp. (Redmond, Wash.), Linux (widely available from multiple sources under open source licenses), or Mac OS from Apple, Inc. The operating system and other application software are stored in the memory 170 of the server 160. This memory 170 typically includes both non-volatile memory, such as solid-state Flash memory and magnetic based hard disk drives, and volatile yet responsive solid state RAM. Application programming and data is stored permanently on the non-volatile memory, and moved to the RAM for faster access when needed by the processor 164.

The memory includes a web server application 172, which instructs the server 160 to respond to data requests associated with particular network addresses (e.g., URLs) with appropriate web page data. In one embodiment, the server 160 responds to the requests differently based upon the current location of the requesting device. To do this, the processor 164 utilizes a variety of data that is stored in the memory 170, including user specific data 174, offer data 176, store location data 178, retailer specific data 180 provided by retailers that sell products 120, and manufacturer data 182 provided by manufacturers of products 120.

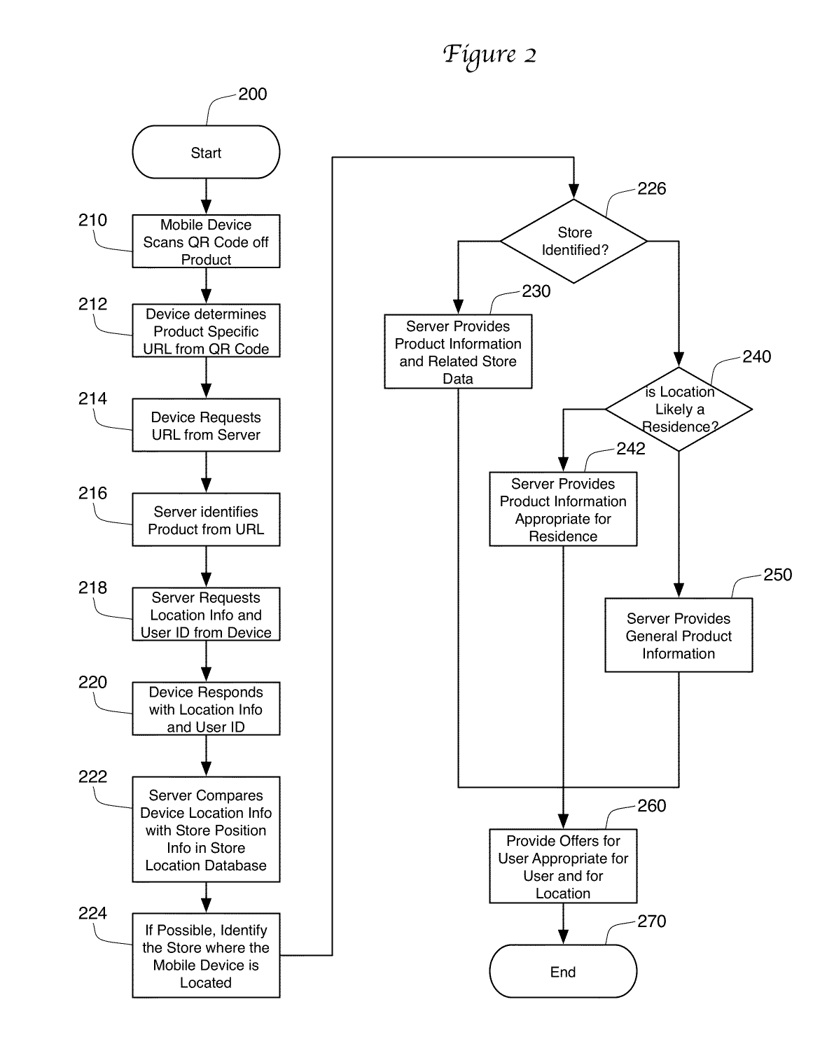

An embodiment of the process used by the system 100 can be seen in the flow chart 200 shown in FIG. 2. The first step 210 of this process is for the mobile device 130 to scan the QR code 110 off of the product 120 or its packaging through its imaging lens 132. Next, at step 212 the mobile device 130 uses the QR code reader app 142 to analyze the QR code 110 and determine a particular network address that is associated with the product 120. If the URL is unique to the product 120, all that is necessary is for the mobile device 130 to instruct a browser app 144 to request the data associated with that address from the remote server 160 at step 214. If the product identifier is separate from the URL in the QR code 110, then the processor 134 must properly formulate the address that will be requested by the browser app 144 in order to identify the product 120 to the server 160.

The web server application 172 running on the processor 164 of server 160 then receives this data request and in step 216 identifies product 120 from the URL. The web server application 172 recognizes that the data to be returned will depend on the geographic location of the mobile device 130. If the mobile device 130 did not transmit its location to the server 160 when it originally requested the product information data, the server will send a request to the device 130 to supply its geographic location. Such a request can be formulated through standard interfaces, such as the geolocation API that forms part of the HTML 5 specification. This request occurs at step 218 of process 200.

In most cases, the browser app 144 will receive the request for geolocation, and will request permission from the user of the mobile device 130 to share this information with the server 160. Assuming that the user agrees, the mobile device 130 determines its location using the location sensor 136, and then provides this information back to the server 160 at step 220. In addition to requesting the user's geographic information, the server 160 may also request that the mobile device 130 identify itself, which in turn helps the server 160 identify the user of the device 130. This identification may take the form of a cookie that uniquely identifies the browser 144 of the mobile device 130 so that the server can identify repeat users of the server 160. The request for this identification can take place at step 218 along with the request for location information, and the return of the cookie can take place at step 220 along with the return of the location information.

The server 160 then compares the device location information received at step 220 with the positions of stores of interest found in the store location data 178. The store location data 178 contains the position of all retail stores locations that are relevant to the server 160. For instance, if the server 160 is operated only for the benefit of a single retailer, the store location data would contain the geographical positions of all of the physical store locations for that retailer. In the preferred embodiment, the server 160 is associated with numerous retailers, including retailers that compete against one another in the sales of the product 120. The location of the various stores of each retailer associated with the server 160 is stored in the store location data 178. This data 178 can be stored as raw data to be analyzed by the web server application 172, or can be stored as part of a separate database application (such as an SQL database) that is queried by the web server application 172. The comparison between the location of the mobile device 130 and the locations of the stores in the store location data 178 happens at step 222. If possible, step 224 then identifies a particular retailer and store location as the location of the mobile device 130.

If a store has been identified, as determined by step 226, the server 160 provides to the mobile device 130 customized product information relating to the product 120 that is appropriate for that store location (step 230). In the preferred embodiment, the customized product information that is returned to the mobile device 130 at step 230 includes identifiers for the identified store location. This might include the store's logo or other trademark. The preferred embodiment also allows the server to accesses data 180 provided by the retailer about that product. This store specific data 180 would include pricing and promotion information for that product at that retail location. For instance, the retailer may have a two-for-one offer on the product, or may be bundling this product with other products at a discount. Because the data 180 can be specific to a particular store location of a retailer, the customized product information returned to the mobile device may include suggestions for accessories that work with that product, and may even include in-store maps and directions to help the user locate and purchase those accessories. The retailer may provide warranty services for the product 120 at additional cost, the details and pricing for which can also be included in the data returned to the mobile device. Finally, the retailer may maintain user feedback data concerning the product, and therefore can provide rating information for the product that was provided by other customers of that retailer.

One thing that would not be provided to the mobile device inside a specific store at step 230 is information concerning competing retailers such as competitive price data. This encourages retailers to promote the existence and use of the system 10 without worrying that the server 160 will provide competitive information to customers already shopping in one of their store locations.

If the mobile device were not located in an identifiable store location, as determined at step 226, step 240 would then determine whether the current location of the mobile device indicates that the user is likely within a residence. This determination could be made by default—any location outside of a known retail store identified at step 224 could be considered a residence. Alternatively, the server 160 may include mapping information either of known residential areas, or known non-residential areas. If residential areas are mapped, the mobile device 130 will be considered to be in a residence if the location information from the device 130 places it within the known residential areas. If known non-residential areas are mapped (such as commercial and industrial areas, national parks, Interstate and other highways, etc.), the mobile device 130 will be considered to be likely in a residence if the location information provided from the device 130 indicates that it is not in a known non-residential area. If both residential and non-residential area information is provided to the server 160, it is possible that some locations will not be located in either areas (i.e., it is not known whether that location is likely to be residential or likely to be non-residential. In this case, the system 100 may default to one type of information (e.g., non-residential information).

If step 240 determines that the mobile device 130 is likely within a residence, the server 160 provides product information to the mobile device 130 that is appropriate for a user in a residence. Since the product information is retrieved in response to a user scanning a QR code 110, it is quite likely that the user has already purchased the product 120. Thus, the product information provided at step 242 will be relevant to owners of the product 120. In particular, the server 160 should provide the customer with information about how to get started using the product 120, and instruction manuals that provide detailed operating instructions for the product 120. This information can come from manufacturer data 182 that is available to the server 160. This manufacturer data 182 can also include specification information from the manufacturer, as well as information about accessories and services provided by the manufacturer. The various retailers that utilize the system 10 can also provide accessory and service information related to the product 120. For instance, store specific offers 176 could be made available to product purchasers (e.g., 20% off of all ink purchases for the purchaser of a particular make and model of printer), and information about these offers 176 could be a prominent part of the product information provided at step 242.

It may be possible to access store or retailer specific data 180 to determine that the particular user of the mobile device 130 purchased the product 120 at a particular retailer. For example, this could be determined by examining customer purchase data in the store's transaction database with the known user of the mobile device 130. In this case, even though the mobile device 130 is not currently within a retail location, the product information sent to the user of the device 130 could be tailored as desired by that retailer. For example, if it is known that the user of the device 130 not only purchased the product 120 from the retailer, but also purchased a product service plan from the retailer, the product information returned by the server 160 could be customized to include information about the service plan, including forms and phone numbers necessary to obtain service for the product 120.

If the location of the mobile device 130 is considered to be neither a known store (step 230), or a likely residence (step 242), then the system 10 will return general product information to the mobile device 130 at step 250. This information could include general product descriptions and detailed specification information from the manufacturer data 182, and consumer and professional reviews of the product. The reviews can be taken from the store specific data 180, or can be general review information available from other locations on the Internet 150. Because the server 160 knows the location of the mobile device 130, the server 160 can provide the device 130 with competitive shopping information including the current selling price of the product 120 at nearby retailers. These retailers can be limited to those retailers participating in the system 100, or can include all retailers for which pricing information is known including Internet-only retailers.

In some embodiments, the process 200 will terminate after the product specific information is provided at either step 230, 242, or 250. In other embodiments, the process 200 continues after each of these steps with step 260. At this step 260, the server analyzes the offer data 176 stored in memory 170 and presents to the user of the device specific offers related to the product 120. As explained above, these offers may relate to particular purchase promotions at a particular store (e.g., two-for-one deals), or to related items such as accessories or warranty services. In the preferred embodiment, the server 160 identifies the user based on the user ID received at step 220 and uses this identifier to locate information about the user in user data 174. This information 174 is then combined with the offer data 176 to customize a promotion based on the product 120, the user data 174, and the offer data 176. This promotion is then provided in the form of an offer along with the product information at step 260. When the offer is provided in step 260, care is taken to ensure that offers from one retailer are not provided to users whose current location is not within the store of a competing retailer. The process then ends at step 270.

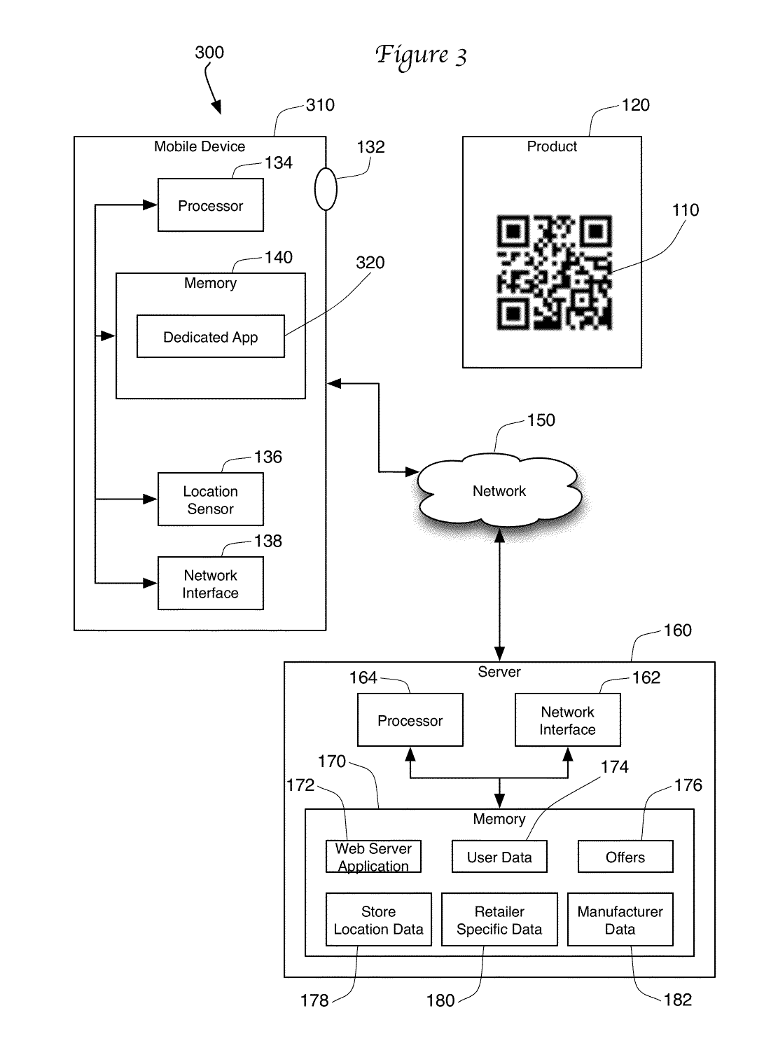

FIG. 3 shows system 300, which illustrates another embodiment of the present invention. This embodiment 300 is similar to the embodiment 100 shown in FIG. 1, and like reference numbers on the two figures refer to the same features. In system 300, the mobile device 310 does not utilize a separate QR code reader application 142 and browser app 144. Instead, mobile device 310 contains a dedicated application 320 that incorporates both the ability to read the QR code 110 and to communicate with the remote server 160 via the network 150. This dedicated application 320 is knowledgeable about the needs of the server 160, and therefore responds to the QR code differently than the separate components 142, 144 of system 100. Rather than merely requesting the URL from the server 160 and waiting for the server 160 to request location and user ID information from the device 130 (step 218 in FIG. 2), the dedicated application 320 sends this information to the server 160 with its original request for product specific information. For instance, this information could be sent as a parameter as part of the URL used to request the product specific information.

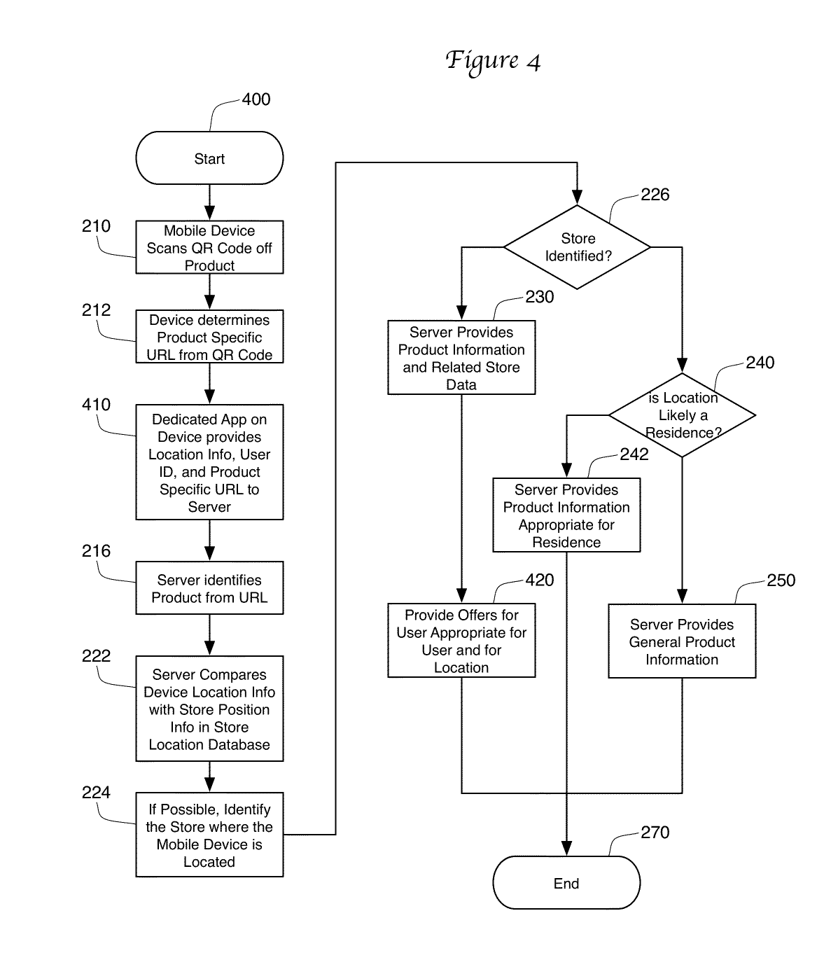

FIG. 4 shows the method 400 by which the mobile device 310 communicates with the server 160 through dedicated application 320. As shown in FIG. 4, the dedicated application 320 sends the location information, user ID, and the product specific URL to the server 160 in its first communication with the server 160 at step 410. This eliminates the need for the server 160 to request this information in a separate step (i.e., step 218 of FIG. 2).

FIG. 4 also shows another variation of the method 200 of FIG. 2, in that the provision of offers to the user that are customized based on the user ID and the location information is provided in step 420 only when the user is determined to be within a retail store location at step 230. Such offers are not provided in this method 400 for other locations. Of course, while it is preferred that offers reflect information known about the user based on the user ID received from the mobile device 310, it is well within the scope of the present invention that the offers delivered in step 420 are based solely on the location and not the identity of the user.

The many features and advantages of the invention are apparent from the above description. Numerous modifications and variations will readily occur to those skilled in the art. For example, although the user data 174, offers 176, store location data 178, store specific data 180, and manufacturer data 182 are shown as residing in the memory 170 of the server 160, this is certainly not required to implement the present invention. Each of these data sources could be located outside of the server 160 and be accessible by the server 160, such as via a connection over the Internet 150. Since such modifications are possible, the invention is not to be limited to the exact construction and operation illustrated and described. Rather, the present invention should be limited only by the following claims.

What is claimed is:

1. A method for providing product specific information comprising:
a) assigning to a computer server a network address that is determinable from a two-dimensional code where the two-dimensional code is associated with a product;
b) receiving, at the computer server at the network address, a request from a first remote device for product specific information relating to the product;
c) receiving, at the computer server, location information for the first remote device;
d) determining, at the computer server and based on the first remote device location information, that the first remote device is within a first store location of a first retailer;
e) customizing, at the computer server, product specific information relating to the product based on the determination of the first retailer, in order to create first customized product specific information; and
f) transmitting the first customized product specific information to the first remote device.

2. The method of claim 1, further comprising:
g) receiving, at the computer server, a request from a second remote device for product specific information relating to the product;
h) receiving, at the computer server, location information for the second remote device;
i) determining, at the computer server and based on the second remote device location information, that the second remote device is within a store location of a second retailer;
j) customizing, at the computer server, product specific information relating to the product based on the determination of the second retailer, in order to create second customized product specific information, wherein the second customized product specific information is different from the first customized product specific information; and
k) transmitting the second customized product specific information to the second remote device.

3. The method of claim 2, further comprising:
l) receiving, at the computer server, a request from a third remote device for product specific information relating to the product;
m) receiving, at the computer server, location information for the third remote device;
n) determining, at the computer server and based on the third remote device location information, that the third remote device is within a second store location of the first retailer;
o) transmitting the first customized product specific information to the third remote device.

4. The method of claim 1, wherein the step of receiving location information for the first remote device further comprises the computer server requesting location information from the first remote device after receiving the first request for product specific information.

5. The method of claim 1, wherein the step of receiving location information for the first remote device further comprises receiving the location information as part of receiving the request for product specific information.

6. The method of claim 1, wherein the step of receiving the request for product specific information further comprises receiving a request for a World Wide Web page at a URL specified by the two-dimensional code.

7. The method of claim 6, wherein the location information for the first remote device is sent as a parameter along with the URL.

8. The method of claim 1, further comprising:
g) receiving, at the computer server, a request for product specific information relating to the product from a second remote device;
h) receiving, at the computer server, location information for the second remote device;
i) determining, at the computer server and based on the second remote device location information, that the second remote device is not within any store location of the first retailer;
j) customizing, at the computer server, product specific information relating to the product for the second remote device, in order to create second customized product specific information, wherein the second customized product specific information contains competitive pricing information for the product including the prices from at least two different retailers, further wherein the first customized product specific information contains only the pricing information for the first retailer; and
k) transmitting the second customized product specific information to the second remote device.

9. The method of claim 1, further comprising
g) generating a first offer from the first retailer to the first remote device concerning the product; and
h) transmitting the first offer to the first remote device.

10. The method of claim 9, wherein the first offer relates to accessories for the product available for purchase at the first store location.

11. The method of claim 10, wherein the first offer includes information about the physical location of the accessories within the first store location.

12. The method of claim 9, further comprising receiving of a first user identification from the first remote device, and further wherein the first offer is customized according to the first user identification.

13. The method of claim 12, wherein the first offer is customized according to past purchase behavior associated with the user identification at the first retailer.

14. The method of claim 1, wherein the network address in the two-dimensional code is a URL specific to the product.

15. A method for requesting product specific information comprising:
a) reading, using a first mobile device, a two-dimensional code associated with a product;
b) determining, at the first mobile device, the network address specific to the product based on the information read from the two-dimensional code;
c) transmitting, from the first mobile device to a remote computer server at the network address, a first request for product specific information relating to the product;
d) transmitting, from the first mobile device to the remote computer server, location information relating to the physical location of the first mobile device; and
e) receiving, at the mobile device from the remote computer server, product specific information customized by the remote computer server according to the physical location of the first mobile device.

16. The method of claim 15, further comprising:
f) reading, using a second mobile device, the two-dimensional code associated with the product;
g) transmitting, from the second mobile device to the remote computer server, a second request for product specific information relating to the product;
h) transmitting, from the second mobile device to the remote computer server, location information relating to the physical location of the second mobile device; and
f) receiving, at the mobile device from the remote computer server, product specific information customized by the remote computer server according to the physical location of the second mobile device;
wherein the physical location of the first mobile device is different than the physical location of the second mobile device, and further wherein the product information received by the first mobile device is different from the product information received by the second mobile device.

17. The method of claim 16, wherein the first mobile device is located within a retail store location of a first retailer, and further wherein the second mobile device is located within a retail store location of a second retailer, wherein the product information received by the first mobile device contains pricing information for the product from the first retailer and not the second retailer, and wherein the product information received by the second mobile device contains pricing information for the product from the second retailer and not the first retailer.

18. The method of claim 16, wherein the first mobile device is located within a retail store location of a first retailer, and further wherein the second mobile device is located within a retail store location of a second retailer, wherein the product information received by the first mobile device contains offer information for the product specific to offers redeemable at the first retailer and not the second retailer, and wherein the product information received by the second mobile device contains offer information for the product specific to offers redeemable at the second retailer and not the first retailer.

19. A computer server for providing product information to mobile devices comprising:
a) a processor for processing software programming instructions;
b) a network interface to a wide area network for communication with a plurality of remote mobile devices;
c) memory containing:
i) a web server application,
ii) store location data,
iii) product specific data including data from the manufacturer of a specific product, and
iv) retailer specific data for a plurality of retailers, including an offer for at least one of the plurality of retailers relating to the specific product; and
d) wherein the web server application includes programming instructions for the processor to:
i) receive a request for product information for the specific product from a first mobile device,
ii) receive location information concerning the physical location of the first mobile device,
iii) determine the retailer location of the first mobile device by comparing the location information received from the first mobile device with store location data, and
iv) return product specific information to the first mobile device, the product specific information being based on the determined retailer location of the first mobile device.

20. The computer server of claim 19, wherein the product specific information includes an offer relating to the specific product for a first retailer and not a second retailer when the first mobile device is determined to be in a retailer location of the first retailer, and further wherein the product specific information includes an offer relating to the specific product for the second retailer and not the first retailer when the first mobile device is determined to be in a retailer location of the second retailer.
